(19) United States
(12) Patent Application Publication
(10) Pub. No.: US 2013/0047933 A1
(43) Pub. Date: Feb. 28, 2013

(54) Apparatus and Method to Protect a Stored Vehicle from Infestation

(71) Applicants: James M. Hider, San Martin, CA (US); Janice Marie Hider, San Martin, CA (US)

(72) Inventors: James M. Hider, San Martin, CA (US); Janice Marie Hider, San Martin, CA (US)

(73) Assignee: Jatcom Corporation, San Martin, CA (US)

(21) Appl. No.: 13/215,215

(22) Filed: Aug. 22, 2011

(51) Int. Cl. A01M 29/12; A01M 29/30

(52) U.S. Cl. 119/712

(57) ABSTRACT

In one embodiment, the present invention includes an apparatus to prevent infestation in vehicles. The apparatus includes a first border, a second border, and a third border disposed on a receptacle. The receptacle interrupts a pathway to the vehicle. The first border includes a tactile barrier providing a repulsive feel for at least a first creature to contact. The second border includes an olfactory blocking powder which prevents olfactory paths from being followed through the second border by at least a second creature. The third border includes an olfactory repellent irritating the nasal passages of at least a third creature.

### CROSS REFERENCE TO RELATED APPLICATIONS

Not applicable.

### BACKGROUND

The present invention relates to vehicle storage, and in particular, to apparatus and method to protect a stored vehicle from infestation.

Recreational vehicles may be stored for long periods of time. For example, restored classic cars, mobile homes, small planes, and boats that represent a large investment by their owners are typically stored for months at a time. Garages, hangers, and long term parking lots provide storage locations for such vehicles, but unfortunately these locations are open to small rodents, cats, and insects which may infest these vehicles when stored over long periods of time. Insects and rodents may feed on interior upholstery. Cats and mice may rip and burrow into the fabric and wood decor of the vehicle and defecate in hidden areas thereby inviting further infestation and bacteria. These potential infestations pose a grave threat to both the investment placed into these vehicles and to the health of the passengers who use them.

### SUMMARY

Embodiments of the present invention reduce infestation in stored vehicles. In one embodiment, the present invention includes an apparatus to prevent infestation in vehicles. The apparatus includes a first border, a second border, and a third border disposed on a receptacle. The receptacle interrupts a pathway to the vehicle. The first border includes a tactile barrier providing a repulsive feel for at least a first creature to contact. The second border includes an olfactory blocking powder which prevents olfactory paths from being followed through the second border by at least a second creature. The third border includes an olfactory repellent irritating the nasal passages of at least a third creature.

In one embodiment, the receptacle forms a cone such that said cone interrupts a hose or cable pathway into the vehicle.

In another embodiment, the cone is formed to attach to the hose or the cable pathway by use of a hook-and-loop fastener having a loop portion. The loop portion is located within the cone, and the first border, the second border, and the third border are disposed within the loop portion.

In one embodiment, the present invention includes an apparatus to protect a vehicle from infestation. The apparatus includes a tactile barrier, an olfactory blocking powder, and an olfactory repellent disposed on a receptacle. The receptacle receives a creature prior to the creature entering the vehicle. The tactile barrier, the olfactory blocking powder, and the olfactory repellent form a coterminous border on the receptacle. The coterminous border includes a ratio of lime to boric acid of no less than 25 to 1, and includes a ratio of lime to pepper of no less than 35 to 1.

In another embodiment, the coterminous border is loosely deposited periodically on the receptacle and the receptacle includes a ridge or at least one wall to prevent the coterminous border from dissipating in the wind.

The following detailed description and accompanying drawings provide a better understanding of the nature and advantages of the present invention.

### BRIEF DESCRIPTION OF THE DRAWINGS

FIG. 1 illustrates an apparatus to protect a vehicle from infestation across a tire according to one embodiment of the present invention.

FIG. 2 illustrates an apparatus to protect a vehicle from infestation across a tire according to another embodiment of the present invention.

FIG. 3 illustrates an apparatus to protect a vehicle from infestation across dually tires according to yet another embodiment of the present invention.

FIG. 4 illustrates an apparatus to protect a vehicle from infestation across levelers or standoffs according to one embodiment of the present invention.

FIG. 5 illustrates an apparatus to protect a vehicle from infestation across an exterior hose or cable according to another embodiment of the present invention.

FIG. 6A-C illustrate an apparatus to protect a vehicle from infestation across an exterior hose or cable according to yet another embodiment of the present invention.

### DETAILED DESCRIPTION

Described herein are techniques for apparatus to reduce infestation of stored vehicles. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

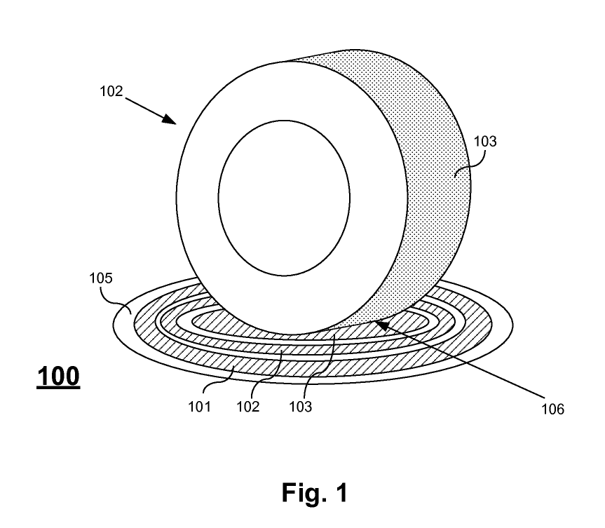

FIG. 1 illustrates an apparatus 100 to protect a vehicle from infestation across tire 102 according to one embodiment of the present invention. Apparatus 100 includes border 101, border 102, and border 103 disposed on top of receptacle 105. Receptacle 105 interrupts the pathway to the vehicle across tire 102 or tire tread 103. Each border (101-103) inhibits at least one type of creature from reaching tire 102 and thereby interrupting the pathway leading to tire 102 and ultimately to the vehicle connected to tire 102.

Border 101 includes a tactile barrier providing a repulsive feel for at least a first creature to contact. Some creatures may be repulsed by the tactile barrier due to texture or other feel. For example, the tactile barrier may be slightly abrasive or sticky or provide some other feel to a passing creature such that the instincts of the creature may be to avoid further contact with the substance or surface. For example, boric acid may have a consistency that repulses some creatures.

Border 102 includes an olfactory blocking powder which prevents olfactory paths from being followed through border 102 by some creatures. Some creatures such as ants use their olfactory sense to follow pathways. Border 102 may block this pathway and prevent infestation. For example, lime may cover an insect's legs and antenna preventing them from using their olfactory senses to make pathways through border 102.

Border 103 includes an olfactory repellent to irritate the nasal passages of at least one creature. Many mammals find certain odors irritating. For example, pepper typically irritates the nasal passages of cats and may inhibit cats from coming close to border 103.

In one embodiment tire 102 makes contact with boarder 103 at point 106. In one scenario, a vehicle having four identical tires like tire 102 is parked above four similar apparatus like apparatus 100 such that each border (e.g. border 101-103) prevent creatures from crawling up the tires and infesting the vehicle.

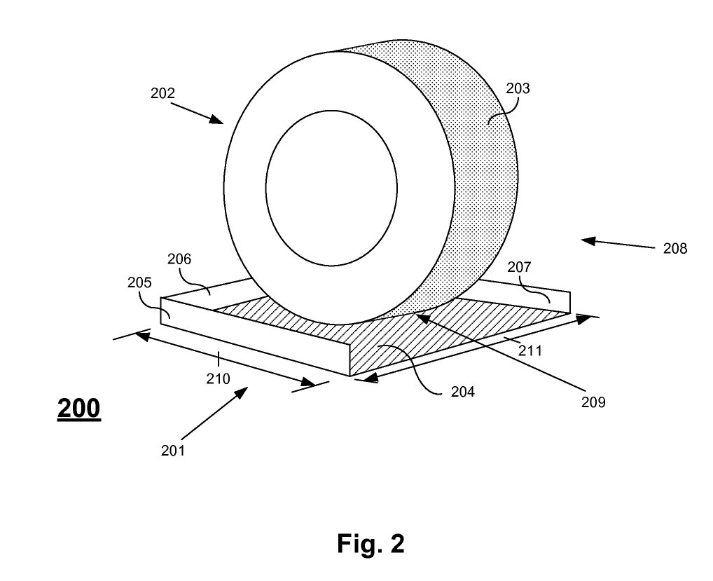

FIG. 2 illustrates an apparatus 200 to protect a vehicle from infestation across a tire 202 according to another embodiment of the present invention. Apparatus 200 includes a receptacle 201 having walls 205-207 to prevent spreading of the material of coterminous border 204. Tire 202 may roll on tread 203 such that it moves in direction 208 to settle on top of coterminous border 204 at point 209 to provide protection to the vehicle (not shown) corresponding to tire 202.

Receptacle 201 interrupts the pathway across the tire which an animal might take to enter the vehicle, and coterminous border 204 includes border 101-103 of apparatus 100 of FIG. 1. In one embodiment, the coterminous border may include a ratio of lime to boric acid of no less than 25 to 1. In another embodiment, the conterminous border 204 may include a ratio of lime to pepper of no less than 35 to 1. Several coterminous borders (e.g. coterminous border 204) for several apparatus (e.g. apparatus 200) may be manufactured by a mixture of 50 lbs. of lime, 1 lbs. of boric acid, and 1 lbs. of pepper.

Apparatus 200 is used for a single tire 202 and may have width 211 of 12-18 inches and depth 210 of 36-40 inches. Walls 205-207 may be 4 inches tall. Receptacle 201 may be manufactured from plastic, wood, metal, or fiberglass. In one embodiment, at least one wall (e.g. wall 205-207) may be used to contain at least the olfactory blocking powder with receptacle (201).

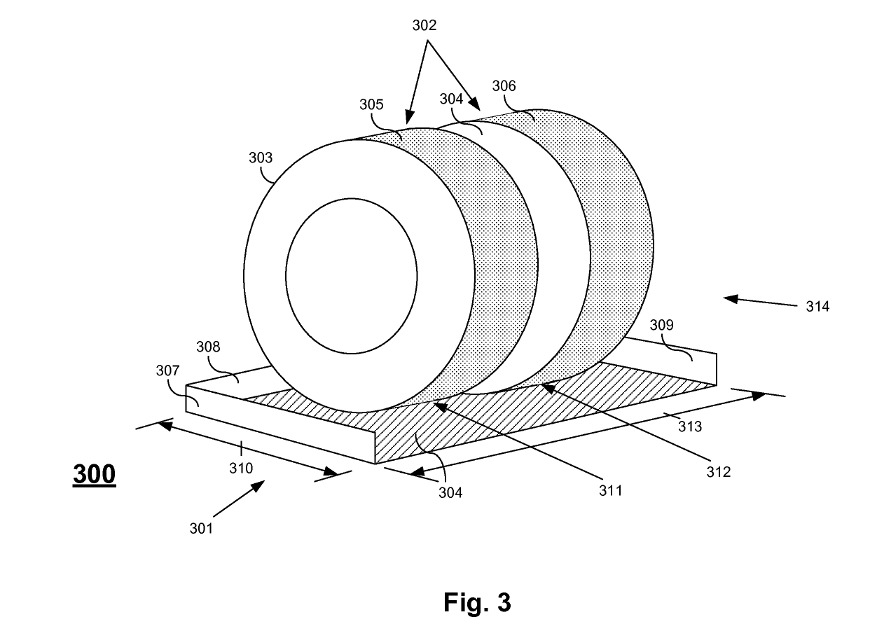

FIG. 3 illustrates an apparatus 300 to protect a vehicle from infestation across dually tires 302 according to yet another embodiment of the present invention. Apparatus 300 includes a receptacle 301 having walls 307-309 to prevent spreading of the material of coterminous border 304. Dually tires 302 may be the rear tires of a mobile home or trailer. Dually tires 302 include tires 303-304 which may roll on treads 305-306 such that dually tires 302 moves in direction 314 to settle on top of coterminous border 304 at point 311-312 to provide protection to a vehicle (not shown) corresponding to dually tires 302. Apparatus 300 may operate similarly to apparatus 200 described above. Apparatus 300 may have width 313 of 24-36 inches and depth 310 of 36-40 inches to fit dually tires 302. Walls 307-309 may be 4 inches tall.

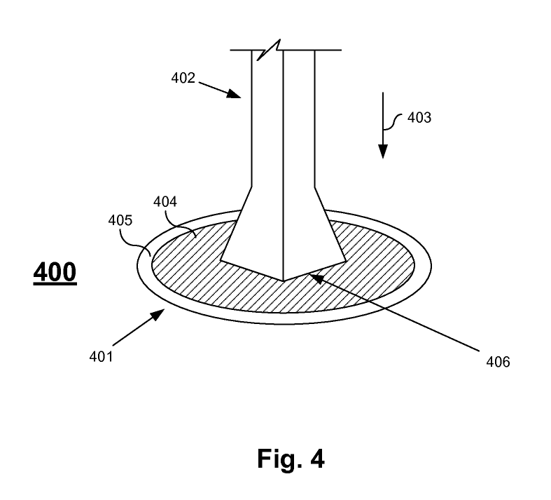

FIG. 4 illustrates an apparatus 400 to protect a vehicle from infestation across levelers 402 or standoffs according to one embodiment of the present invention. Apparatus 400 includes coterminous boarder 404 disposed onto receptacle 401. Receptacle 401 may include a ridge 405 to help contain materials of coterminous boarder 404. Leveler 402 may be moved a vertical direction 403 to make contact with coterminous boarder 404 and/or receptacle 401 at point 406. Coterminous border 404 may be similar to coterminous border 204 of FIG. 2. Receptacle 401 may be circular with a diameter of 24 inches to accommodate different sizes of levelers of standoffs which may be available on various models of trailers and mobile homes. In one embodiment, ridge 405 may be used to contain at least the tactile barrier within receptacle 401. Apparatus 400 helps to reduce infestation of animals within a vehicle corresponding to leveler 402 or standoff.

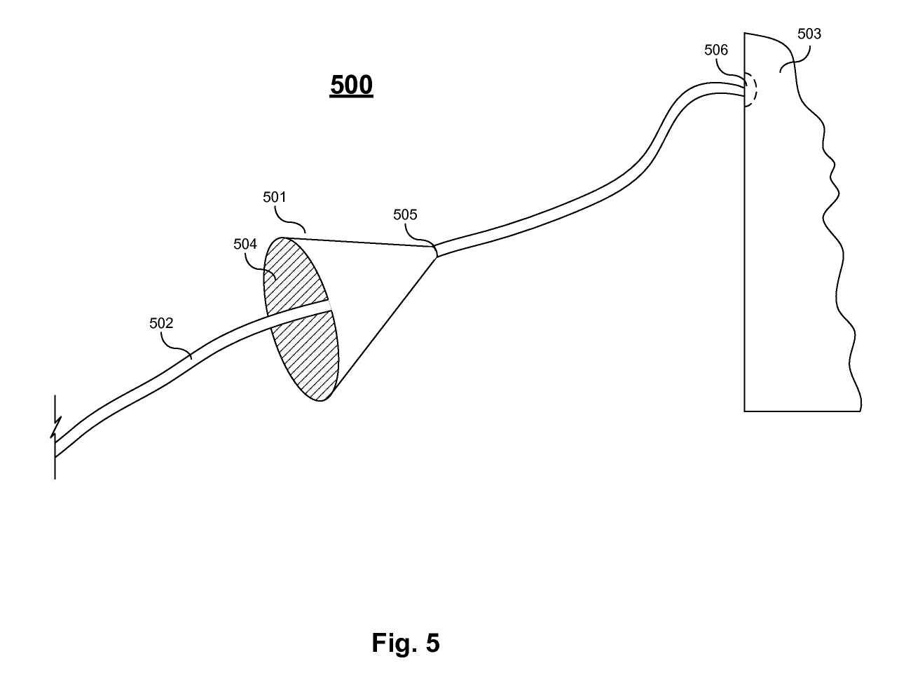

FIG. 5 illustrates an apparatus 500 to protect a vehicle 503 from infestation across an exterior hose/cable 502 according to another embodiment of the present invention. Many recreational vehicles may be connected to utilities using hoses and cables. Hose or cable 502 and opening 506 may provide an alternate path for infestation. Apparatus 500 protects vehicle 503 from infestation across hose/cable 502.

Apparatus 500 includes receptacle 501 having coterminous boarder 504 inside of the cone shape. Receptacle 501 is coupled to hose/cable 502 at location 505. A creature (e.g. rodent or insect) may crawl up hose/cable, but receptacle interrupts the pathway and provides coterminous boarder 504 which inhibits the creature from passing to opening 506 and infesting vehicle 503.

Apparatus 500 may be manufactured to work on power cords having ⅝ or 5/16 inch O.D. (outside diameter) or T.V. cables of similar dimensions. Apparatus 500 may also be manufactured for ¾ inch O.D. hose, or phone cables having ⅜ inch O.D. or ¼ inch O.D. In one embodiment apparatus 500 includes a strap or tie wrap to secure location 505 to hose/cable 502.

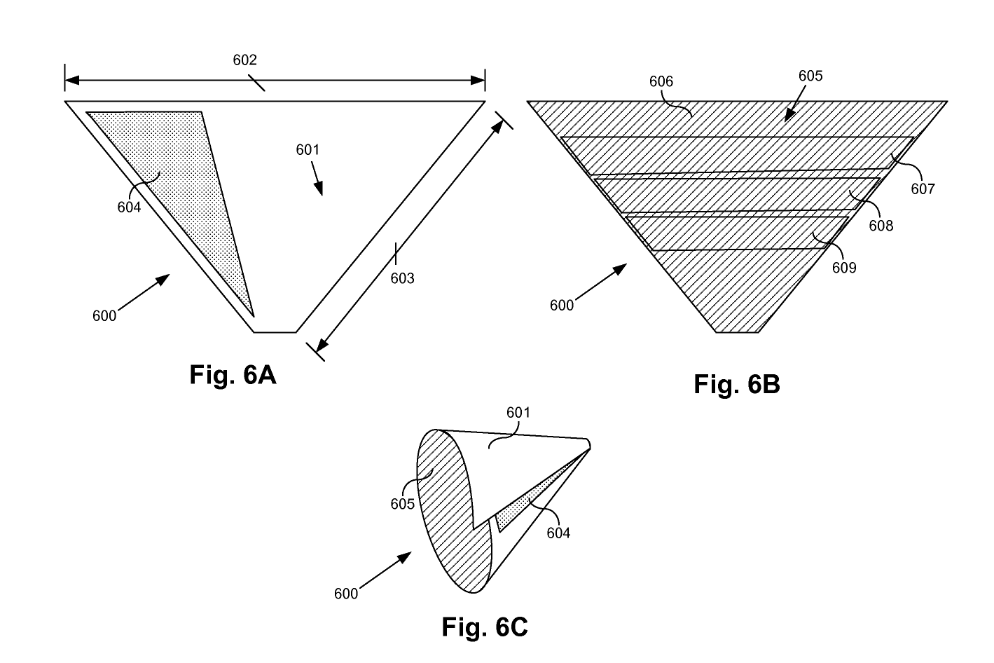

FIG. 6A-C illustrate an apparatus 600 to protect a vehicle from infestation across an exterior hose or cable according to yet another embodiment of the present invention. Apparatus 600 may be an adjustable embodiment similar to apparatus 500 of FIG. 5. Apparatus 600 forms a cone to attach to a hose or cable pathway as shown in FIG. 5. Apparatus 600 attaches to the hose/cable 502 (FIG. 5) by using a hook-and-loop fastener. A coterminous or non-coterminous set of borders (as described above for FIGS. 1-2) may be disposed on a loop portion of the hook-and-loop fastener in order to protect the vehicle (not shown) from infestation.

FIG. 6A shows a flat view of the top side 601 of apparatus 600. Apparatus 600 forms an equilateral triangle and may be made of a semi-rigid plastic that allows the apparatus 600 to be rolled into a cone shape during installation. Alternate shapes may be manufactured to provide different conical shapes. Apparatus 600 may have length 602 of 12 inches and a length 603 of 8½ inches in one embodiment. A hook section 604 may be shaped like a triangle shown. This may be attached hook material known as Velcro®.

FIG. 6B shows a flat view of the bottom side 605 of apparatus 600. Bottom side 605 may be entirely covered with loop material 606. A coterminous border may be disposed on the entire loop material 606. In an alternate embodiment, borders 101-103 (of FIG. 1) may be disposed in sections 607-609 respectively. In one embodiment, 3 strips of double sided tape may be used to attach borders 101-103 (of FIG. 1) to sections 607-609. Loop material 606 may capture the materials (e.g. lime, boric acid, pepper) within its fabric thereby providing suitable borders (or a coterminous border).

FIG. 6C shows a three dimensional view of apparatus 600 as assembled. Hook section 604 is used to attach to loop material 606 to form the cone. The fine curls of the loop material have captured the border material establishing a coterminous border within the cone similar to apparatus 200 of FIG. 2. The cone material may be plastic or any semi-rigid material which allows bending.

The above description illustrates various embodiments of the present invention along with examples of how aspects of the present invention may be implemented. The above examples and embodiments should not be deemed to be the only embodiments, and are presented to illustrate the flexibility and advantages of the present invention. For example, although these embodiments may be used ideally for RVs, they may be used also with trailers (e.g. fifth wheels), trucks with bed campers, boats, planes, or any other vehicle requiring protection from infestation. Based on the above disclosure, other arrangements, embodiments, implementations and equivalents will be evident to those skilled in the art and may be employed without departing from the spirit and scope of the invention.

What is claimed is:

1. An apparatus to prevent infestation in vehicles, said apparatus comprising:
a receptacle interrupting a pathway to said vehicle;
a first border disposed on said receptacle which includes a tactile barrier providing a repulsive feel for at least a first creature to contact;
a second border disposed on said receptacle which includes an olfactory blocking powder which prevents olfactory paths from being followed through said second border by at least a second creature; and
a third border disposed on said receptacle which includes an olfactory repellent irritating the nasal passages of at least a third creature.

2. The apparatus of claim 1 wherein said first border, said second border, and said third border form a coterminous border.

3. The apparatus of claim 2 wherein said coterminous border includes a ratio of lime to boric acid of no less than 25 to 1.

4. The apparatus of claim 2 wherein said coterminous border includes a ratio of lime to pepper of no less than 35 to 1.

5. The apparatus of claim 1 wherein said receptacle includes at least one wall to contain at least said olfactory blocking powder within said receptacle.

6. The apparatus of claim 1 wherein said receptacle includes a ridge to contain at least said tactile barrier.

7. The apparatus of claim 1 wherein said receptacle forms a cone such that said cone interrupts a hose or cable pathway into said vehicle.

8. The apparatus of claim 7 wherein said cone is formed to attach to said hose or said cable pathway by use of a hook-and-loop fastener having a loop portion, wherein said loop portion is located within said cone and wherein said first border, said second border, and said third border are disposed within said loop portion.

9. An method to prevent infestation in vehicles, said method comprising:
interrupting a pathway to said vehicle with a receptacle;
disposing a first border on said receptacle which includes a tactile barrier providing a repulsive feel for at least a first creature to contact;
disposing a second border on said receptacle which includes an olfactory blocking powder which prevents olfactory paths from being followed through said second border by at least a second creature; and
disposing a third border on said receptacle which includes an olfactory repellent irritating the nasal passages of at least a third creature.

10. The method of claim 9 wherein said disposing includes said first border, said second border, and said third border forming a coterminous border.

11. The apparatus of claim 10 wherein said forming said coterminous border includes a ratio of lime to boric acid of no less than 25 to 1 deposited on said receptacle.

12. The apparatus of claim 10 wherein said forming said coterminous border includes a ratio of lime to pepper of no less than 35 to 1 deposited on said receptacle.

13. The apparatus of claim 9 further comprising containing at least said olfactory blocking powder within said receptacle by at least one wall of said receptacle.

14. The apparatus of claim 9 further comprising containing at least said tactile barrier within a ridge of said receptacle.

15. The apparatus of claim 9 further comprising forming a cone as said receptacle such that said cone interrupts a hose or cable pathway into said vehicle.

16. The apparatus of claim 15 wherein said forming said cone includes attaching said cone to said hose or said cable pathway by use of a hook-and-loop fastener having a loop portion, wherein said loop portion is located within said cone and wherein said first border, said second border, and said third border are disposed within said loop portion.

17. An apparatus to protect a vehicle from infestation, said apparatus comprising:
a receptacle to receive a creature prior to said creature entering said vehicle;
a tactile barrier disposed on said receptacle;
an olfactory blocking powder disposed on said receptacle;
an olfactory repellent disposed on said receptacle,
wherein said tactile barrier, said olfactory blocking powder, and said olfactory repellent form a coterminous border on said receptacle, wherein said coterminous border includes a ratio of lime to boric acid of no less than 25 to 1, and wherein said coterminous border includes a ration of lime to pepper of no less than 35 to 1.

18. The apparatus of claim 17 wherein said coterminous border is loosely deposited periodically on said receptacle and said receptacle includes a ridge or at least one wall to prevent said coterminous border from dissipating in the wind.
